(19) United States
(12) Patent Application Publication
(10) Pub. No.: US 2026/0356203 A1
(43) Pub. Date: Nov. 12, 2026

(54) METHOD AND APPARATUS FOR DISCONNECTING BATTERY BASED ON PREDICTION OF VEHICLE COLLISION POSSIBILITY

(71) Applicant: ELECTRONICS AND TELECOMMUNICATIONS RESEARCH INSTITUTE, Daejeon (KR)

(72) Inventors: Jooyoung Kim, Daejeon (KR); Yongwoo Jo, Daejeon (KR); Kyoung-Wook Min, Daejeon (KR); Jeong Dan Choi, Daejeon (KR)

(21) Appl. No.: 19/643,001

(22) Filed: Apr. 9, 2026

(30) Foreign Application Priority Data
May 12, 2025 (KR) 10-2025-0060915

(51) Int. Cl. B60L 3/00

(52) U.S. Cl. CPC B60L 3/0007; B60L 2240/60

(57) ABSTRACT

Provided is a method of disconnecting a battery based on prediction of a collision probability of a vehicle. The method of disconnecting a battery includes acquiring sensing data about surroundings of the target vehicle, estimating first future path data of the target vehicle and second future path data of one or more nearby vehicles near the target vehicle based on the sensing data, calculating collision probabilities between the target vehicle and the nearby vehicles based on the first future path data and the second future path data, and determining whether to disconnect a second battery designated as a disconnection target among batteries mounted on the target vehicle based on the collision probabilities.

### CROSS-REFERENCE TO RELATED APPLICATION

This application claims priority to and the benefit of Korean Patent Application No. 10-2025-0060915, filed on May 12, 2025, the disclosure of which is incorporated herein by reference in its entirety.

### BACKGROUND

### 1. FIELD OF THE INVENTION

The present invention relates to a method and apparatus for predicting the possibility of a vehicle collision based on recognition of the vehicle’s surrounding environment and disconnecting a battery present in the vehicle when an impact above a threshold is expected.

### 2. DESCRIPTION OF RELATED ART

As the climate crisis intensifies, efforts to reduce carbon dioxide emissions are being undertaken across society as a whole. As part of these efforts, electric vehicles (hereinafter referred to as “EVs”), which are driven using electrical energy of batteries, are being rapidly deployed to replace internal combustion engine vehicles, which are one of the major sources of carbon emissions. According to a column contributed to the Korean Society of Automotive Engineers (KSAE) in 2022 by Professor Min Kyoungdoug of Seoul National University, the transportation sector accounts for approximately 16.2% of global greenhouse gas emissions.

However, in recent years, incidents and accidents caused by fires in large-capacity batteries installed in electric vehicles have been occurring frequently, becoming a social issue. As the most representative example, in 2024, a fire broke out in an electric vehicle parked in Incheon Metropolitan City, resulting in more than 140 vehicles in the underground parking lot being completely burned or scorched, and approximately 480 households in the complex suffering damage from the fire.

The causes of such electric vehicle battery fires are often related to external impacts or overcharging. Separators of lithium-ion batteries installed in most electric vehicles may be damaged due to deformation when subjected to external impacts. This causes internal short circuits leading to thermal runaway, which results in rapid temperature increases causing severe damage and making suppression difficult. Even when a fire does not occur immediately at the time of impact, the risk of a fire occurring later due to internal damage is high. Therefore, it is recommended that batteries subjected to sudden impacts be recovered and undergo safety inspection. However, this process not only consumes time and cost in itself, but the cost may increase significantly when the battery needs to be replaced.

Korean Utility Model Publication No. 20-1998-0013259 (published on Jun. 5, 1998) discloses, in a battery set of an electric vehicle composed of a plurality of batteries, a method in which switching means are coupled to output terminals of the respective batteries so that, when necessary, such as in the event of a vehicle accident, the batteries may be individually disconnected, thereby preventing accidents caused by high voltage. In this method, when an impact detection sensor detects an external impact, a relay switch contact is changed from a normally closed contact to a normally open contact, thereby cutting off the power output of the battery after the occurrence of the impact.

Korean Laid-open Patent Publication No. 10-2022-0130632 (published on September 27, 2022) discloses a method for forcibly disconnecting some batteries when a fire occurs in an electric vehicle battery. The method provides a method and apparatus for forcibly disconnecting a battery package from an electric vehicle chassis platform through a battery forced separation device when a fire is detected through a temperature sensor and a flame detector. Since this method involves separating the battery after a fire has occurred, the battery may remain damaged even after separation.

### SUMMARY OF THE INVENTION

The present invention aims to provide a method and an apparatus by which, in order to prevent a battery fire, when a collision is expected in a vehicle equipped with a battery, all or part of the battery is safely disconnected, thereby minimizing the possibility of a fire caused by impact.

Specifically, the present invention aims to provide a method and apparatus that are capable of, in a vehicle equipped with a sensor, a computing device, and a battery, disconnecting the battery when a collision of the vehicle is expected based on information recognized through the sensor, to prevent an impact exceeding a risk level from being applied to the battery.

The technical objectives of the present invention are not limited to the above, and other objectives that are not described above may become apparent to those of ordinary skill in the art based on the following descriptions.

According to an embodiment of the present invention, there is provided a method of disconnecting a battery, which is performed by a target vehicle equipped with one or more batteries.

The method includes: acquiring sensing data about surroundings of the target vehicle; estimating first future path data of the target vehicle and second future path data of one or more nearby vehicles near the target vehicle based on the sensing data; calculating collision probabilities between the target vehicle and the nearby vehicles based on the first future path data and the second future path data; and determining whether to disconnect a second battery designated as a disconnection target among batteries mounted on the target vehicle based on the collision probabilities.

According to an embodiment of the present invention, there is provided a vehicle equipped with a battery. The vehicle includes: a power source including a first battery and a second battery; a sensor that acquires sensing data about surroundings; and a processor that estimates first future path data of the target vehicle and second future path data of one or more nearby vehicles near the target vehicle based on the sensing data; calculates collision probabilities between the target vehicle and the nearby vehicles based on the first future path data and the second future path data; and determines whether to disconnect a second battery designated as a disconnection target among batteries mounted on the target vehicle based on the collision probabilities.

According to an embodiment of the present invention, there is provided an apparatus for disconnecting a battery, which is mounted on a target vehicle.

The apparatus includes: a sensor that acquires sensing data about the surroundings; a memory that stores computer-readable instructions; at least one processor implemented to execute the instructions; and a battery disconnector that disconnects a battery mounted on the vehicle.

The at least one processor executes the instructions to: estimate first future path data of the target vehicle and second future path data of one or more nearby vehicles near the target vehicle based on the sensing data; calculate collision probabilities between the target vehicle and the nearby vehicles based on the first future path data and the second future path data; and determine whether to disconnect a second battery designated as a disconnection target among batteries mounted on the target vehicle based on the collision probabilities.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a vehicle and an apparatus for disconnecting a battery mounted on the vehicle according to an embodiment of the present invention;

FIG. 2 is a block diagram for describing a process in which an apparatus for disconnecting a battery according to an embodiment of the present invention generates path data of a target vehicle and nearby vehicles based on sensing data; and

FIG. 3 is a flowchart for describing a method of disconnecting a battery according to an embodiment of the present invention.

### DETAILED DESCRIPTION OF EXEMPLARY EMBODIMENTS

The present invention relates to a method and apparatus for predicting a collision possibility and an impact force of a vehicle based on recognition of a surrounding environment of the vehicle and disconnecting a battery present in the vehicle when the predicted collision possibility and the impact force are greater than or equal to a threshold.

The present invention aims to provide a method and apparatus capable of, in a vehicle equipped with a sensor, a computing device, and a battery, disconnecting the battery when a collision of the vehicle is expected based on information recognized through the sensor, to prevent an impact exceeding a risk level from being applied to the battery.

The scope of the present invention includes a method and apparatus for recognizing the spacing and relative speed between objects or structures such as vehicles or walls using vehicle-mounted sensors, and through path prediction of an own vehicle and nearby objects, calculating a collision possibility with the own vehicle, and when a collision is expected, disconnecting all or part of the battery before the collision.

In addition, methods and apparatuses for protecting a disconnected battery are also included in the scope of the present invention.

In this case, the vehicle equipped with sensors or batteries is not limited to an electric vehicle, and a vehicle equipped with a separate power supply system including batteries for operating specific equipment requiring electricity inside the vehicle may also be included in the scope of the present invention. A hybrid-type vehicle equipped with both an internal combustion engine and an electric drive system may also be included in the scope of the present invention.

The source of electrical energy is likewise not limited to a simple battery (secondary batteries) and may include a fuel cell, a solar cell, or the like. However, for convenience of description, the present specification is described with reference to an electric vehicle that is driven by an electric motor and uses a battery as an energy source.

The advantages and features of the present invention and ways of achieving them will become readily apparent with reference to the detailed description of the following embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the description and understanding of the embodiments and are not intended to limit the scope and spirit of the present invention. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when a first element is referred to as being “connected” or “coupled” to a second element, the first element can be directly connected or coupled to the second element or intervening elements may be present. In contrast, when an element is referred to as being “directly connected” or “directly coupled” to another element, there are no intervening elements present. Other words used to describe the relationships between elements should be interpreted in a like fashion (i.e., “between” versus “directly between,” “adjacent” versus “directly adjacent,” etc.).

In the description of the present invention, when it is determined that a detailed description of related technology may unnecessarily obscure the gist of the present invention, the detailed description will be omitted.

Hereinafter, embodiments of the present invention will be described with reference to the accompanying drawings in detail. For better understanding of the present invention, the same reference numerals are used to refer to the same elements throughout the description of the drawings.

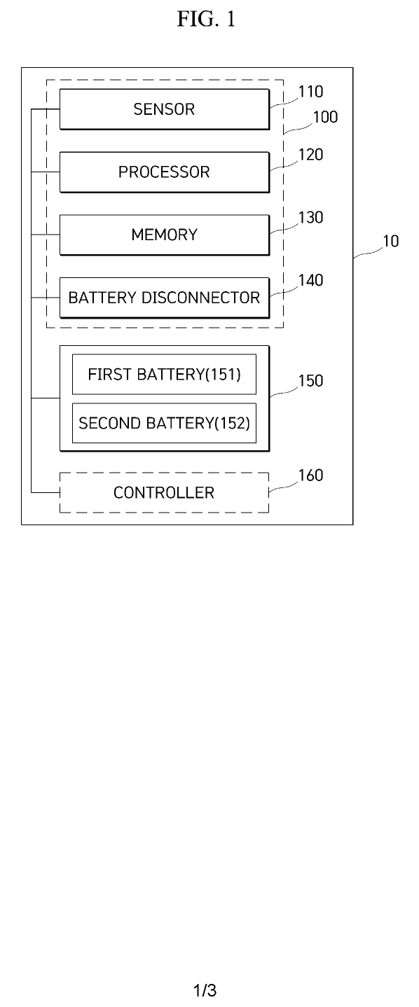

FIG. 1 is a block diagram illustrating a configuration of a vehicle and an apparatus for disconnecting a battery mounted on the vehicle according to an embodiment of the present invention.

As shown in FIG. 1, a vehicle 10 includes an apparatus 100 for disconnecting a battery and a power source 150 and may further include a controller 160.

The apparatus 100 for disconnecting a battery includes a sensor 110, a processor 120, a memory 130, and a battery disconnector 140.

The vehicle 10 and the apparatus 100 for disconnecting a battery shown in FIG. 1 are based on one embodiment, and components of the vehicle 10 or the apparatus 100 for disconnecting a battery according to the present invention are not limited to the embodiment shown in FIG. 1, and some components may be added, changed, or deleted as needed.

The vehicle 10 is equipped with a battery. The power source 150 includes a first battery 151 and a second battery 152. In the present invention, the first battery 151 is a battery that is not a disconnection target, and the second battery 152 is a battery designated as a disconnection target.

Hereinafter, the vehicle 10 will be referred to as a “target vehicle” to distinguish it from vehicles near the vehicle 10.

The sensor 110 acquires sensing data about the surroundings. The processor 120 estimates first future path data of the target vehicle 10 and second future path data of one or more nearby vehicles near the target vehicle based on the sensing data, calculates a collision probability between the target vehicle 10 and the nearby vehicles based on the first future path data and the second future path data, and determines whether to disconnect the second battery 152 designated as a disconnection target among batteries mounted on the target vehicle 10 based on the collision probability.

Meanwhile, the vehicle 10 may estimate third future path data of objects other than nearby vehicles (e.g., pedestrians) based on the sensing data.

The second battery 152 may be determined based on at least one or a combination of a battery material and a battery capacity.

The processor 120 may input the sensing data into a neural network-based learning model to estimate the first future path data and the second future path data in the process of estimating the first future path data and the second future path data. In this process, the processor 120 may additionally estimate third future path data for objects other than nearby vehicles, in addition to the first future path data and the second future path data. That is, the processor 120 may additionally generate third future path data for objects other than nearby vehicles by inputting the sensing data into a neural network-based learning model.

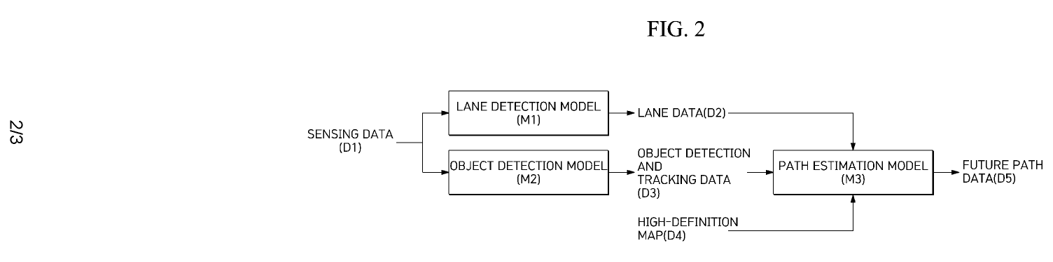

FIG. 2 is a block diagram for describing a process in which an apparatus for disconnecting a battery according to an embodiment of the present invention generates path data of a target vehicle and nearby vehicles based on sensing data.

As shown in FIG. 2, the learning model used by the processor 120 to estimate the first future path data and the second future path data may include a lane detection model M1, an object detection model M2, and a path estimation model M3. The processor 120 may input sensing data D1 into the lane detection model M1 to generate lane data D2, input sensing data D1 into the object detection model M2 to generate object detection and tracking data D3, and input the lane data D2, the object detection and tracking data D3, and previously acquired high-precision map D4 into the path estimation model M3 to generate first future path data, which is future path data of the target vehicle, and second future path data, which is future path data of nearby vehicles. Future path data D5 of FIG. 2 includes the first future path data and the second future path data.

Returning to FIG. 1, the functions of the processor 120 will be described.

In the process of determining whether to disconnect the second battery 152, the processor 120 may determine to maintain the first battery 151, which is not a disconnection target among the batteries mounted on the target vehicle 10, and disconnect the second battery 152 designated as a disconnection target when there is a collision probability greater than or equal to a predetermined threshold among the collision probabilities between the target vehicle 10 and nearby vehicles.

In the process of calculating the collision probability, the processor 120 may calculate collision directions and impact forces between the target vehicle 10 and nearby vehicles based on the first future path data and the second future path data.

In the process of determining whether to disconnect the second battery 152, the processor 120 may be configured to determine whether to disconnect the second battery 152 based on a collision direction and an impact force of a nearby vehicle having a collision probability greater than or equal to a predetermined threshold. For example, the processor 120 may calculate a total impact force that a nearby vehicle is expected to apply to the vehicle 10 based on the collision direction and the impact force of the nearby vehicle having a collision probability greater than or equal to the threshold, and may determine to disconnect the second battery 152 when the total impact force is greater than or equal to a predetermined threshold impact force.

The battery disconnector 140 may disconnect the battery from the vehicle 10 using a driving force such as hydraulic pressure. The present invention does not limit a driving method of the battery disconnector 140. The battery disconnector 140 may include an actuator (e.g., a hydraulic cylinder), an air injector, a communication device, a signal generator, and a processor.

For example, when the processor 120 determines to disconnect the second battery 152, the battery disconnector 140 may, upon control of the processor 120 (that is, upon transmission of a battery disconnection signal), wrap the second battery 152 with a protective material (e.g., an air cap, a bubble wrap, or an airbag), and then disconnect and drop the second battery 152 from the vehicle 10.

Specifically, the battery disconnector 140 may inject compressed air through a built-in nozzle to bring the protective material into close contact with the second battery 152 and may disconnect the second battery 152 sealed with the protective material from the vehicle 10 using a hydraulic actuator (e.g., a hydraulic cylinder). In this process, the battery disconnector 140 may apply vibration to a coupling part (e.g., a screw) between the second battery 152 and the vehicle 10 using a piezoelectric actuator to facilitate disconnection of the second battery 152.

As another example, when the processor 120 determines to disconnect the second battery 152, the battery disconnector 140 may drop a protective material for mitigating the impact between the second battery 152 and the ground at a position in which the second battery 152 is to be disconnected and dropped, immediately before the second battery 152 is disconnected and dropped to the ground.

As another example, the protective material described above may be an airbag including an ignition device. In this case, the airbag is filled with a chemical substance (e.g., sodium azide (NaN₃)) that may generate a large amount of gas (e.g., nitrogen) upon ignition. Under normal circumstances, the airbag may be mounted outside the second battery 152. For example, the airbag may be mounted to surround the second battery 152 while spaced apart from the outside of the second battery 152 at a certain distance. When a collision is expected or when a collision occurs and the processor 120 determines to disconnect the second battery 152, the processor 120 transmits an electric signal to the ignition device simultaneously with (or before or after) transmitting a battery disconnection signal to the battery disconnector 140. When the ignition device generates a spark due to the electric signal, the airbag may be instantly (e.g., within 0.08 to 0.1 seconds) inflated and deployed to protect the second battery 152. Assuming that when the second battery 152 is mounted on the vehicle 10, the height (a ground clearance) of a lower end of the second battery 152 relative to the ground is 10 cm, it takes 0.14 seconds (=√2×0.1 m/g, where g is gravitational acceleration) for the second battery 152 to free fall. Accordingly, the airbag may be deployed while the second battery 152 is falling to the ground and may protect the second battery 152 from collision with the ground, preventing damage and ignition. In this example, the method described above (hydraulic actuator and vibration) may be applied as the method by which the battery disconnector 140 disconnects the second battery 152 from the vehicle. Although the present example describes the processor 120 transmitting an electric signal to the ignition device of the airbag, there may be an embodiment in which the battery disconnector 140 transmits an electric signal to the ignition device.

Meanwhile, the processor 120 may determine a disconnection direction of the battery disconnector 140 based on the collision direction and transmit the disconnection direction to the battery disconnector 140 so that the battery disconnector 140 drops the second battery 152 according to the disconnection direction. For example, in order to prevent additional risks caused by disconnecting and discharging the second battery 152 from the vehicle 10, the processor 120 may determine the disconnection direction to be opposite to the collision direction between the vehicle 10 and the nearby vehicle.

As another example, the processor 120 may determine the disconnection direction of the battery disconnector 140 based on the second future path data representing the future path of nearby vehicles and/or the third future path data representing the future path of nearby pedestrians, and transmit the disconnection direction to the battery disconnector 140 so that the battery disconnector 140 drops the second battery 152 according to the disconnection direction. For example, the processor 120 may recognize future paths of vehicles and pedestrians near the vehicle 10 from the second future path data and the third future path data, determine the disconnection direction toward a space in which the probability of nearby vehicles and nearby pedestrians entering within a predetermined time is minimum, and transmit the disconnection direction to the battery disconnector 140.

Hereinafter, the vehicle 10 of FIG. 1 will be described in detail.

The vehicle 10 may, through a sensor 110 including sensors required for recognizing surrounding environment information such as a camera, a radar, a light detection and ranging (LiDAR), and the Global Positioning System (GPS), and a processor 120 that processes sensing data generated by the sensor 110, recognize nearby objects and the environment by itself, and determine a collision risk based thereon.

In this case, the sensor 110 is not limited to a specific type or number, and multiple types/numbers of sensors may be used in combination. Based on sensing data generated by the sensors, the processor 120 may recognize and track nearby lanes, structures, vehicles, pedestrians, and the like, and may calculate a collision risk, a collision direction, and an impact force upon collision. The method of recognition and tracking and the calculation of collision risk/direction and impact force are not limited to any specific method. In addition to nearby objects, recognizing the position of the own vehicle may also be included, but such information may not be required. When such a vehicle is equipped with a controller 160, the vehicle may perform a certain level of autonomous driving, but this may not be required. In addition, methods of receiving recognition results from platforms, surrounding infrastructure, or vehicles through communication devices (not shown) may also be included in the scope of the invention.

The power source 150 of the vehicle 10 includes a battery and a battery management system (BMS) and stably supplies power to parts that require electricity in the vehicle, such as vehicle driving, the sensor 110, or the processor 120. In this case, the battery of the power source 150 may be divided into a first battery 151 and a second battery 152. The first battery 151 stores a small amount of power that allows the vehicle to perform minimum operations even when a collision occurs. Since the possibility of battery fire is related to energy density, a low-capacity battery is relatively safe, and therefore the first battery is not disconnected even during a collision and continues to supply minimum power to the vehicle. In this case, to enhance stability, a battery formed of a material with low energy density rather than lithium-ion, or a battery to which special technical measures are applied may be employed as the first battery 151. The second battery 152 is a large-capacity battery used for driving and the like and is composed of a plurality of cells. When a collision is expected, the second battery 152 is safely disconnected from the vehicle 10 to prevent additional damage caused by fire after impact. However, the first battery and the second battery need not be configured separately, and even a single battery may achieve the object of the present invention by being disconnected when a collision is expected. As another embodiment for achieving the object of the present invention, disconnecting only some cells expected to be damaged, among a plurality of cells constituting a second battery 152, according to the impact direction and impact force in the second battery 152 may also be included in the scope of the present invention.

The method and apparatus for disconnecting a battery according to an embodiment of the present invention may be a method and apparatus for safely disconnecting a portion of a battery when a collision is expected by predicting paths of nearby vehicles.

In the above embodiment, the processor 120 inputs sensing data transmitted from a sensor 110 such as cameras, LiDAR, and RADAR into a deep neural network to recognize lanes and detects objects such as nearby vehicles and pedestrians. To predict the trajectory of the target vehicle 10 (own vehicle), the processor 120 may recognize the position of the target vehicle 10 using GPS alone or by fusing GPS with the sensors. In this case, the deep neural network may be composed of separate neural networks for object detection or may be configured to simultaneously recognize objects using a single neural network, but for convenience of description, it is described as including separate neural networks as shown in FIG. 2.

When the processor 120 detects objects near the vehicle 10 based on sensing data, the processor 120 assigns each object a unique ID that may identify each object and continuously tracks the objects based on characteristic information. The processor 120 may input the continuous position or past path information of tracked vehicles into a path estimation model M3 that receives trajectories over a past specific time and predicts trajectories over a future specific time, thereby predicting future driving trajectories (second future path data) of the vehicles. In this case, to improve prediction accuracy, high-precision map information or recognized lane information may be provided as another input value of the path estimation model M3. The position recognition result of the target vehicle 10 (own vehicle) using GPS and the like may also be input into the path estimation model M3 for predicting future trajectories to predict a future driving trajectory (first future path data).

Through these processes, when predicted trajectories (future path data) of the target vehicle 10 and a nearby vehicle match at a specific point in time, the processor 120 may predict that a collision will occur. In addition, the processor 120 may calculate an impact force by calculating a relative speed based on the speed of each vehicle at a time when a collision is expected to occur.

In this case, prediction of trajectories and calculation of collision possibility are not limited to using a deep neural network. As another embodiment for calculating collision possibility, the processor 120 may calculate the collision possibility by calculating a time to collision (TTC) by extending vehicle trajectories when the direction of the target vehicle 10 or other vehicles does not match the lane direction or deviates from the center of the lane based on recognized lane information and the position and past trajectory information of the target vehicle 10 and nearby vehicles.

Since collision estimation is based on observation of movements of the target vehicle 10 and nearby vehicles, the processor 120 may also predict the collision direction. When a collision is expected, the processor 120 may control the battery disconnector 140 to disconnect the second battery 152 from the vehicle 10 when damage to the battery is estimated to be greater than or equal to a certain level considering the impact direction and impact force. In this case, the first battery 151 is not removed or disconnected and remains mounted on the vehicle to supply minimum necessary power so that driving and control states may be maintained.

In this case, the second battery 152 disconnected from the vehicle 10 may receive impact due to collision with the ground while falling and may also receive impact by remaining as a fallen object on the road causing secondary accidents with following vehicles. Since the purpose of disconnecting the second battery 152 from the vehicle 10 is to prevent fire and the like caused by impact, as another embodiment of the present invention, the battery disconnector 140 may deploy protective materials to prevent impact during battery disconnection and/or notify of the presence of a fallen object to the outside of the vehicle 10 (or nearby vehicles) through lighting or light-emitting devices to prevent secondary damage. In this case, the type of protective materials or light sources, and the locations, sizes, and the like of the light-emitting device are not limited to specific types.

As another embodiment, a method and apparatus for protecting a battery when a collision with nearby structures or an object in a driving environment is expected may be provided.

In the embodiment, based on sensing data generated by the sensor 110, the processor 120 recognizes the position of the target vehicle 10 and the presence and shapes of nearby structures or objects. The structures may include speed bumps, road shapes, curbs, median strips, guard rails, car stoppers, fire hydrants, piping, traffic cones, road debris, trees, and the like which may cause damage upon collision with the vehicle, and are not limited to specific types. As a method of recognizing nearby structures or objects, a method of using a deep neural network with camera images as input values; or a method in which information on speed bumps, curbs and the like is stored and provided in a high-precision map may be employed; however, the method is not limited to a specific method.

The processor 120 predicts whether an impact and damage to the vehicle are likely to occur due to structures or objects considering the recognized information and related information of the target vehicle 10. In this case, information related to the own vehicle used for prediction may include the vehicle size (e.g., an overall length, an overall width, etc.), a height (e.g., an overall height, a ground clearance, etc.), a wheelbase, a current driving lane and a position in the lane, a speed, and the like, and the prediction method is not limited to a specific method. When an impact is expected according to the prediction result, the processor 120 may minimize damage by deploying protective materials through the battery disconnector 140 or disconnecting the battery. When disconnecting the battery, deployment of the protective material and lighting of a light-emitting device may be performed to prevent collateral damage as described above.

As a more detailed embodiment, when the sensor 110 and the processor 120 recognize the presence of a speed bump in front of the driving path of the target vehicle 10, and an impact is expected based on the height of the speed bump and the shape and speed of the vehicle, a lower protective material for protecting the battery may be deployed through the battery disconnector 140. As another embodiment, when a steep slope is recognized on the road on which the target vehicle 10 is driving (e.g., an underground parking lot), and an impact to a lower portion of the vehicle is expected considering the vehicle shape (especially the length, the wheelbase, and the ground clearance), the processor 120 may deploy a lower protective material to protect the battery through the battery disconnector 140.

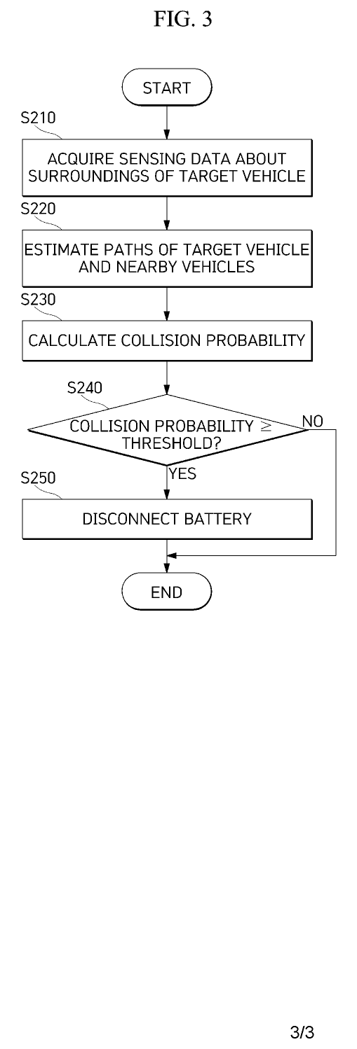

FIG. 3 is a flowchart for describing a method of disconnecting a battery according to an embodiment of the present invention.

Referring to FIG. 3, the method of disconnecting a battery according to an embodiment of the present invention includes operations S210 to S250. The method of disconnecting a battery shown in FIG. 3 is based on one embodiment, and the operations of the method of disconnecting a battery according to the present invention are not limited to the embodiment shown in FIG. 3, and some operations may be added, changed, or deleted as needed.

The method of disconnecting a battery may be performed by a vehicle 10 equipped with one or more batteries. In this embodiment, it is assumed that the power source 150 included in the vehicle 10 includes a first battery 151 and a second battery 152, the first battery 151 is a battery that is not a disconnection target, and the second battery 152 is a battery designated as a disconnection target in case of emergency. For example, the second battery 152 may be determined based on at least one or a combination of a battery material and a battery capacity.

In operation S210, the vehicle 10 acquires sensing data around the vehicle 10 through the sensor 110. The sensor 110 recognizes environment information around the vehicle 10. For example, the sensor 110 may include at least one of a camera, a RADAR, a LiDAR, or GPS.

In operation S220, the vehicle 10 estimates future path data of the vehicle 10 and nearby vehicles based on the sensing data. Specifically, the vehicle 10 estimates first future path data of the vehicle 10 itself and second future path data of one or more nearby vehicles near the vehicle 10 based on the sensing data. The vehicle 10 may estimate third future path data of objects other than nearby vehicles (e.g., pedestrians) based on the sensing data.

In operation S230, the vehicle 10 calculates a collision probability based on the future path data. Specifically, the vehicle 10 calculates collision probabilities between the vehicle 10 and vehicles near the vehicle 10 based on the first future path data and the second future path data.

For example, the vehicle 10 may input the sensing data into a neural network-based learning model to estimate the first future path data and the second future path data. The learning model may include a lane detection model, an object detection model, and a path estimation model. In this case, the vehicle 10 generates lane data by inputting the sensing data into the lane detection model, generates object detection and tracking data by inputting the sensing data into the object detection model, and generates the first future path data and the second future path data by inputting the lane data, the object detection and tracking data, and a previously acquired (or stored) high-precision map into the path estimation model. In this process, the vehicle 10 may additionally generate third future path data for objects other than nearby vehicles, in addition to the first future path data and the second future path data. The vehicle 10 calculates collision probabilities between the target vehicle 10 and nearby vehicles based on the first future path data and the second future path data. In the process of calculating a collision probability, the vehicle 10 may calculate a collision direction and an impact force between the target vehicle 10 and a nearby vehicle based on the first future path data and the second future path data.

In operation S240, the vehicle 10 determines whether the collision probability is greater than or equal to a threshold to determine whether to proceed to operation S250. That is, when the collision probability is greater than or equal to the threshold, operation S250 is performed; otherwise, the process ends. The vehicle 10 determines whether to disconnect the second battery 152 designated as a disconnection target based on the collision probability calculated in operation S230. When it is determined to disconnect the second battery 152, operation S250 proceeds.

As another example, when the vehicle 10 has calculated the collision directions and the impact forces of nearby vehicles in the process of calculating the collision probability, the vehicle 10 may determine whether to disconnect the second battery 152 based on the collision direction and the impact force of a nearby vehicle having a collision probability greater than or equal to a predetermined threshold. That is, the vehicle 10 may determine whether to proceed to operation S250 by considering not only the collision probability but also the collision directions and impact forces of nearby vehicles. For example, the vehicle 10 may calculate the total impact force that a nearby vehicle is expected to apply to the vehicle 10 based on the collision direction and impact force of the nearby vehicle having a collision probability greater than or equal to the threshold, and may determine to disconnect the second battery 152 when the total impact force is greater than or equal to a predetermined threshold impact force.

In operation S250, the vehicle 10 disconnects the second battery 152. In this case, the vehicle 10 maintains the first battery 151, which is not a disconnection target.

For example, when it is determined to disconnect the second battery 152, the vehicle 10 may wrap the second battery 152 with a protective material (e.g., an air cap, a bubble wrap) and then disconnect and drop the second battery 152 from the vehicle 10.

Specifically, the vehicle 10 may inject compressed air through a built-in nozzle to bring the protective material into close contact with the second battery 152, and may disconnect the second battery 152 sealed with the protective material from the vehicle 10 using a hydraulic actuator (e.g., a hydraulic cylinder). In this process, the vehicle 10 may weaken the coupling force of a coupling part (e.g., screws) between the second battery 152 and the vehicle 10 by applying vibration to the coupling part using a piezoelectric actuator to facilitate disconnection of the second battery 152.

As another example, when the vehicle 10 determines to disconnect the second battery 152, immediately before the second battery 152 is disconnected and dropped to the ground, the vehicle 10 may drop a protective material for mitigating the impact between the second battery 152 and the ground at a position at which the second battery 152 is to be disconnected and dropped to the ground.

As another example, the protective material described above may be an airbag including an ignition device. In this case, the airbag is filled with a chemical substance (e.g., sodium azide (NaN₃)) that may generate a large amount of gas (e.g., nitrogen) upon ignition. Under normal circumstances, the airbag may be mounted outside the second battery 152. For example, the airbag may be mounted to surround the second battery 152 while spaced apart from the outside of the second battery 152 at a certain distance. When a collision is expected or when a collision occurs and the processor 120 determines to disconnect the second battery 152, the processor 120 transmits an electric signal to the ignition device simultaneously with (or before or after) transmitting a battery disconnection signal to the battery disconnector 140. When the ignition device generates a spark due to the electric signal, the airbag may be instantly (e.g., within 0.08 to 0.1 seconds) inflated and deployed to protect the second battery 152. Assuming that when the second battery 152 is mounted on the vehicle 10, the height (a ground clearance) of a lower end of the second battery 152 relative to the ground is 10 cm, it takes 0.14 seconds (=√2×0.1 m/g, where g is gravitational acceleration) for the second battery 152 to free fall. Accordingly, the airbag may be deployed while the second battery 152 is falling to the ground and may protect the second battery 152 from collision with the ground, preventing damage and ignition. In this example, the method described above (hydraulic actuator and vibration) may be applied as the method by which the battery disconnector 140 disconnects the second battery 152 from the vehicle. Although the present example describes the processor 120 transmitting an electric signal to the ignition device of the airbag, there may be an embodiment in which the battery disconnector 140 transmits an electric signal to the ignition device.

Meanwhile, the vehicle 10 may determine a direction to drop the second battery 152 (a disconnection direction) based on the collision direction and may drop the second battery 152 according to the disconnection direction. For example, to prevent additional risks caused by disconnecting and discharging the second battery 152 from the vehicle 10, the vehicle 10 may determine the disconnection direction to be opposite to the collision direction between the vehicle 10 and a nearby vehicle.

As another example, the vehicle 10 may determine the disconnection direction based on the second future path data representing the future paths of nearby vehicles and/or the third future path data representing the future paths of nearby pedestrians, and may drop the second battery 152 according to the disconnection direction. For example, the vehicle 10 may recognize the future paths of vehicles and pedestrians near the vehicle 10 from the second future path data and the third future path data, determine the disconnection direction toward a space in which the probability of nearby vehicles and nearby pedestrians entering within a predetermined time is minimum, and disconnect the second battery 152 in the disconnection direction. For example, when the future paths of nearby vehicles are distributed from a position corresponding to the 11 o'clock direction to a position corresponding to the 5 o'clock direction of the vehicle 10, the disconnection direction may be determined as the 2 o'clock direction of the vehicle 10.

The method of disconnecting a battery has been described above with reference to the flowchart presented in the drawings. While the above method has been shown and described as a series of blocks for the purpose of simplicity, it is to be understood that the present invention is not limited to the order of the blocks, and that some blocks may be executed in a different order from that shown and described herein or executed concurrently with other blocks, and various other branches, flow paths, and sequences of blocks that achieve the same or similar results may be implemented. In addition, not all illustrated blocks may be required for implementation of the method described herein.

Meanwhile, in the description with reference to FIG. 3, each operation may be further divided into a larger number of sub-operations or combined into a smaller number of operations according to examples of implementation of the present invention. In addition, some of the operations may not be performed or the order of operations may be changed as needed. In addition, even in the case of omitted content, the content of FIG. 1 and 2 may be applied to the content of FIG. 3.

As is apparent from the above, the present invention has effects of preventing fire damage caused by battery damage and reducing enormous costs and environmental pollution associated with battery replacement.

Vehicle damage caused by traffic accidents, speed bumps, slopes, and the like occurs frequently. In general, batteries of electric vehicles are mounted in a lower portion of the vehicle, and even minor impact or damage to the batteries can cause a fire resulting in substantial damage. Accordingly, as the adoption rate of electric vehicles increases, potential risks can increase rapidly. Even when battery damage is detected before a fire occurs, batteries are expensive, and repair or replacement causes significant financial loss to vehicle owners. The method and apparatus proposed by the present invention can reduce such risks and damage. For reference, media reports have introduced cases in which an entire battery had to be replaced due to a scratch of approximately 3 mm formed in a battery housing of an electric vehicle, with replacement costs reaching approximately KRW 70 million (https://newautopost.co.kr/issue-plus/article/126141/#google_vignette).

According to the method and apparatus provided by the present invention, when a collision possibility of a vehicle is estimated, a battery can be safely disconnected, thereby preventing a primary fire. In addition, by avoiding direct impact, the battery can be protected from damage, and the disconnected battery can be recovered later and reused or recycled. As described above, even very minor damage, such as a 3 mm scratch in a battery housing, can be fatal to a battery. Accordingly, the present invention can achieve significant effects in preventing substantial loss of human life and property.

The effects of the present disclosure are not limited to the effects described above, and other effects that are not described will be clearly understood by those skilled in the art from the above detailed description.

Although the present invention has been described in detail above with reference to exemplary embodiments, those of ordinary skill in the technical field to which the present invention pertains should be able to understand that various modifications and alterations may be made without departing from the technical spirit and scope of the present invention.

What is claimed is:

1. A method of disconnecting a battery, which is performed by a target vehicle equipped with one or more batteries, the method comprising:
acquiring sensing data about surroundings of the target vehicle;
estimating first future path data of the target vehicle and second future path data of one or more nearby vehicles near the target vehicle based on the sensing data;
calculating collision probabilities between the target vehicle and the nearby vehicles based on the first future path data and the second future path data; and
determining whether to disconnect a second battery designated as a disconnection target among batteries mounted on the target vehicle based on the collision probabilities.

2. The method of claim 1, wherein the second battery is determined based on at least one or a combination of a battery material and a battery capacity.

3. The method of claim 1, wherein the estimating of the future path data includes inputting the sensing data into a neural network-based learning model to estimate the first future path data and the second future path data.

4. The method of claim 3, wherein:
the learning model includes a lane detection model, an object detection model, and a path estimation model, and
the estimating of the future path data includes:
inputting the sensing data into the lane detection model to generate lane data;
inputting the sensing data into the object detection model to generate object detection and tracking data; and
inputting the lane data, the object detection and tracking data, and a previously acquired high-precision map into the path estimation model to generate the first future path data and the second future path data.

5. The method of claim 1, wherein the determining of whether to disconnect the second battery further includes,
when there is a collision probability greater than or equal to a predetermined threshold among the collision probabilities, maintaining a first battery that is not a disconnection target among the batteries mounted on the target vehicle and disconnecting the second battery designated as a disconnection target.

6. The method of claim 1, wherein the calculating of the collision probabilities further includes calculating collision directions and impact forces between the target vehicle and the nearby vehicles based on the first future path data and the second future path data, and
wherein the determining of whether to disconnect the second battery further includes determining whether to disconnect the second battery based on the collision direction and the impact force of a nearby vehicle having a collision probability greater than or equal to a predetermined threshold.

7. The method of claim 1, wherein, when it is determined to disconnect the second battery, a protective material is brought into contact with the second battery, and then the second battery is dropped in a predetermined disconnection direction.

8. A target vehicle equipped with a battery, comprising:
a power source including a first battery and a second battery;
a sensor that acquires sensing data about surroundings; and
a processor that estimates first future path data of the target vehicle and second future path data of one or more nearby vehicles near the target vehicle based on the sensing data;
calculates collision probabilities between the target vehicle and the nearby vehicles based on the first future path data and the second future path data; and
determines whether to disconnect a second battery designated as a disconnection target among batteries mounted on the target vehicle based on the collision probabilities.

9. The target vehicle of claim 8, wherein the second battery is determined based on at least one or a combination of a battery material and a battery capacity.

10. The target vehicle of claim 8, wherein the processor, in a process of estimating the first future path data and the second future path data, inputs the sensing data into a neural network-based learning model to estimate the first future path data and the second future path data.

11. The target vehicle of claim 10, wherein the learning model includes a lane detection model, an object detection model, and a path estimation model, and
the processor inputs the sensing data into the lane detection model to generate lane data,
inputs the sensing data into the object detection model to generate object detection and tracking data, and
inputs the lane data, the object detection and tracking data, and a previously acquired high-precision map into the path estimation model to generate the first future path data and the second future path data.

12. The target vehicle of claim 8, wherein the processor, in a process of determining whether to disconnect the second battery, determines to maintain a first battery that is not a disconnection target among the batteries mounted on the target vehicle and disconnect the second battery designated as a disconnection target when there is a collision probability greater than or equal to a predetermined threshold among the collision probabilities.

13. The target vehicle of claim 8, wherein the processor, in a process of calculating the collision probabilities, calculates collision directions and impact forces between the target vehicle and the nearby vehicles based on the first future path data and the second future path data, and in a process of determining whether to disconnect the second battery, determines whether to disconnect the second battery based on the collision direction and the impact force of a nearby vehicle having a collision probability greater than or equal to a predetermined threshold.

14. The target vehicle of claim 8, wherein, when it is determined to disconnect the second battery, the vehicle brings a protective material into close contact with the second battery and then drops the second battery in a predetermined disconnection direction.

15. An apparatus for disconnecting a battery, which is mounted on a target vehicle, the apparatus comprising:
a sensor that acquires sensing data about the surroundings;
a memory that stores computer-readable instructions;
at least one processor implemented to execute the instructions; and
a battery disconnector that disconnects a battery mounted on the vehicle,
wherein the at least one processor executes the instructions to:
estimate first future path data of the target vehicle and second future path data of one or more nearby vehicles near the target vehicle based on the sensing data;
calculate collision probabilities between the target vehicle and the nearby vehicles based on the first future path data and the second future path data; and
determine whether to disconnect a second battery designated as a disconnection target among batteries mounted on the target vehicle based on the collision probabilities.

16. The apparatus of claim 15, wherein the second battery is determined based on at least one or a combination of a battery material and a battery capacity.

17. The apparatus of claim 15, wherein the processor, in a process of estimating the first future path data and the second future path data, inputs the sensing data into a neural network-based learning model to estimate the first future path data and the second future path data.

18. The apparatus of claim 17, wherein the learning model includes a lane detection model, an object detection model, and a path estimation model, and
the processor inputs the sensing data into the lane detection model to generate lane data,
inputs the sensing data into the object detection model to generate object detection and tracking data, and
inputs the lane data, the object detection and tracking data, and a previously acquired high-precision map into the path estimation model to generate the first future path data and the second future path data.

19. The apparatus of claim 15, wherein the processor, in a process of determining whether to disconnect the second battery, determines to maintain a first battery that is not a disconnection target among the batteries mounted on the target vehicle and disconnect the second battery designated as a disconnection target when there is a collision probability greater than or equal to a predetermined threshold among the collision probabilities.

20. The apparatus of claim 15, wherein the processor, in a process of calculating the collision probabilities, calculates collision directions and an impact forces between the target vehicle and the nearby vehicles based on the first future path data and the second future path data, and in a process of determining whether to disconnect the second battery, determines whether to disconnect the second battery based on the collision direction and the impact force of a nearby vehicle having a collision probability greater than or equal to a predetermined threshold.
